(19) United States
(12) Patent Application Publication
(10) Pub. No.: US 2007/0279375 A1
(43) Pub. Date: Dec. 6, 2007

(54) Method and circuit for controlling a display apparatus

(75) Inventors: Didier Ploquin, Parthenay de Bretagne (FR); Philippe Marchand, Vitre (FR); Gerard Morizot, Voiron (FR)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(73) Assignee: Thomson Licensing

(21) Appl. No.: 11/805,432

(22) Filed: May 23, 2007

(30) Foreign Application Priority Data
Jun. 2, 2006 (EP) 06290910.6

(51) Int. Cl. G09G 3/36

(52) U.S. Cl. 345/102

(57) ABSTRACT

In a display device images are reproduced by controlling the amount of light provided by a light source by means of light modulators for individual pixels. Subsequent images are synchronised to each other by synchronisation signals regularly occurring at intervals corresponding to first time periods. The backlight is controlled to emit light during fractions of second time periods or whole second time periods which are equal to or shorter than first time periods. Several of the second time periods may be nested and evenly distributed within the first time period. The signals for driving the backlight are preferably generated in synchronism with the horizontal pixel clock. Each of the fractions of second time periods or whole second time periods during which light is emitted is divided into a number of elementary steps, wherein each elementary step corresponds to a number of pixel clock periods. The number of elementary steps is chosen according to the desired ratio of control of the backlight or contrast ratio, e.g. 100 elementary steps for a contrast ratio of 1:100. During each of the second time periods the backlight is controlled to be on for a number of elementary steps corresponding to the desired contrast ratio.

### FIELD OF THE INVENTION

The invention relates to display apparatus using transmissive light valves that modulate light emitted by a backlight to form an image. The invention also relates to display apparatus such as projection displays, in which light is modulated by reflective light valves.

### BACKGROUND OF THE INVENTION

A light valve is controlling the amount of light that is visible on a screen. The term display will be used in the following without distinguishing between displays that use reflective or transmissive light valves. Typically, each light valve represents one pixel of the image. In the case of a colour image reproduction a triplet of light valves for the primary colours red, green and blue may be used for one pixel, thereby allowing for composing a wide variety of colours by mixing the primary colours correspondingly. In this case, the backlight typically is a uniform white light. It is also possible to produce colour images by sequentially producing monochromatic images of the primary colours. In this case, mixing of the colours is performed in the observer's eye by integration of the monochromatic images over time. Today's display apparatus often use liquid crystals as transmissive light valve, which are controlled for transmitting a desired amount of light from the backlight towards a front surface of the apparatus. The front surface of the apparatus is also referred to as a screen. Projection display apparatus may also use reflective light valves formed by micro mirrors, also known as DMD, or liquid crystals on silicon, also referred to as LCOS.

Today's liquid crystal displays, or LCD, offer a contrast ratio in the range of 1:1000. This is due to light leaking through a fully closed light valve. However, the human eye is capable of discerning contrast ratios in the range of 1:100.000. It is generally known from the prior art to control the intensity of an LCD backlight in order to improve the contrast ratio of the display. In this case the backlight of the display apparatus is adjusted to provide the highest brightness required for a pixel in the image that is to be reproduced. Common display apparatus using light valves are equipped with gas discharge lamps as a backlight, for example cold cathode fluorescent lamps, also referred to by the acronym CCFL, or gas discharge lamps in general. Further, arc lamps or halogen lamps may be used, in particular in projection devices. The brightness of those commonly used backlights is controlled, e.g., by varying the supply voltage and/or the current through the lamps.

Only recently light emitting diodes, or LEDs, have been available which provide the required amount of light to be useful as a backlight or projection light source for a display apparatus as referred to in this specification. The LEDs may either be LEDs emitting white light or may be formed by triplets of LEDs each emitting light in a primary colour, wherein white light is obtained by mixing the primary colours accordingly, either simultaneously or sequentially over time. However, conventional dimming of LEDs by accordingly controlling the current through the LEDs also results in a change in the perceived colour, which is generally undesirable.

In order to overcome the change in the perceived colour it is known to use currents having constant magnitude for driving the LEDs and to switch these currents having constant magnitude in a pulsed manner in order to achieve the desired perceived light intensity. The perceived light intensity depends on the number and/or duration of the pulses. To this end, a circuit for setting the duty cycle is generally known which includes a PLL stage that is locked to the vertical synchronisation pulse of the video signal. In the known circuit a counter/comparator is used for setting the duty cycle in accordance with the vertical synchronisation pulse.

FIG. 3 shows a prior art circuit which can be used for setting the duty cycle of a backlight. The prior art circuit is based on a PLL-controlled oscillator the frequency of which can be controlled. A PLL oscillator 101 is locked to the frame frequency by means of a synchronisation signal VB. Each output signal period of oscillator 106 represents one elementary step, similar as shown FIG. 1 by the line labelled ES. The output signal 106 of the oscillator is used as a clock signal to a counter 103. A count value DC is supplied to the counter 103, and the counter counts until the count value is reached. The output of the counter BLC then changes its state, similar to the line labelled BLC of FIG. 1, thereby controlling a backlight to be on or off. The counter 103 is reset and counting begins anew when a new period begins. It is also possible to divide a frame period into sub-periods, in which case the counter is reset and counting begins anew at the end of each sub-period. To this end, the output of the PLL oscillator 101 is divided in a divider 102 by the desired number CR of elementary steps composing each sub-period. The output of the divider 102 is supplied to the load input of counter 103 as well as to the input of a divider 104 for counting the desired number n of sub-periods composing each frame. The output of divider 104 is fed back to the PLL oscillator for synchronisation with the VB frame signal. The main feedback loop of the PLL circuit is thus provided by the two dividers 102 and 104. Divider 102 divides the elementary steps corresponding to signal 106 by a control range CR value. Divider 102 output signal represents each sub-period composing each frame as represented by the bottom-most line of FIG. 1. Typically CR is set to 100. Divider 104 divides the sub-period by the number n of required sub-periods to compose the total frame period.

The clock frequency of the oscillator exactly equals n*CR*f_frame, wherein n is the number of sub-periods, CR is the desired range of control of the backlight and f_frame is the repetition rate of frames in the video signal. In order to allow for a control ratio of the backlight of 1:100 CR equals 100. The prior art circuit is not synchronised with the pixel clock and can thus not easily be integrated in a digital circuit for controlling image properties that may be provided anyway. Further, although PLL circuits may be easily integrated into digital ICs they often have properties which are not compatible with the requirement in terms of reference clock supplied and frequencies of the video signal. In fact, PLL circuits supplied in digital integrated circuits are often limited to generating multiples of fraction of clock signals within the IC, which frequency may be rather high. In order to properly operate with the rather low frame frequencies of video signals PLL circuits may have to be provided externally to the digital integrated circuit. Generally, such PLL circuits with low frequency locked loop are subject to functioning and stability problems.

### SUMMARY OF THE INVENTION

It is, therefore, desirable to provide a method and a circuit for controlling a backlight that relies only on signals associated and synchronised with the video signal. It is further generally desirable to achieve a control ratio of the backlight that is independent of the video mode in which the display is currently operating.

The method as defined in claim 1 and the dependent sub-claims as well as the apparatus as defined in claim 11 and the dependent sub-claims present a solution for controlling a backlight, which relies only on signals associated and synchronised with the video signal and provides a control of the backlight substantially independent of the video mode in which the display is currently operating.

According to the invention the backlight is controlled to emit light during fractions of second time periods, which second time periods are equal to or shorter than first time periods. The first time periods may correspond to a vertical synchronisation period of a video signal or to a frame period. Several of the second time periods may be nested and distributed within the first time period, the distribution preferably being substantially even and regular and the length of the second time periods being preferably substantially equal. The backlight is controlled to emit light during fractions of or whole second time periods. In the case more than one second time periods are accommodated within the first time period, for those second time periods belonging to the same first time period, the fractions of the second time periods, during which the light source is controlled to emit light, preferably have the same relative length with regard to the respective second time period. The ratio between the fraction and the second time period then corresponds to a desired second contrast ratio. The signals for driving the backlight are preferably generated in synchronism with the vertical and/or horizontal pixel clock. A number of pixel clock periods correspond to an elementary step or third time period, and each of the second time periods is divided into a number of third time periods. The number of elementary steps is chosen according to the desired ratio of control of the backlight or contrast ratio, e.g. 100 elementary steps in a second time period for a contrast ratio range of 1:100. During each of the second time periods the backlight is controlled to be on for a number of elementary steps, or fourth time periods, corresponding to the desired contrast ratio.

Distribution of the second time intervals, or sub-periods, within the frame period, or first time period, and of the elementary steps, or fourth time periods, within the sub-periods, or second time periods, is accomplished by counting pixel clock pulses, or third time periods. Counters are supplied with respective values corresponding to the number of sub-periods per frame period and the number of elementary steps per sub-period for different video modes. In a development of the invention an error that may still be present when the distribution of the pixel clock pulses of one frame amongst the sub-periods result in a non-integer number of pixel clock pulses per sub-period is distributed in regular intervals during a frame such that the total error during a frame is cancelled.

The invention allows for displaying contrast ratios for example in the range of 1:100.000 by combining the contrast ratios that can be achieved by the light modulator itself and the contrast ratio achievable by accordingly adapting the backlight. A possible variation in the perceived image colour that may be present in the case of a linear regulation of the backlight, which cannot always be compensated for by accordingly driving the LCD panel, is avoided.

The invention will be described in the following specification with reference to an LCD screen having an LED backlight. However, the inventive driving method may be applied to any light source that can be switched at the required frequency, also including but not limited to OLED.

In order to avoid artifacts that may occur when the light modulator is addressed and provided with new image content, it is advantageous to synchronise begin or end of the time period during which the light source emits light with a synchronisation signal indicating the beginning or the end of a new image. This is particularly important when the image content changes from one image to another as is usually the case in movie pictures or video content in general. In the case of a television signal the synchronisation signal is, e.g., the vertical synchronisation signal indicating the start of a field or a frame. The term field refers to a half image that is used in interlaced video display and the term frame refers to a full image that is used in progressive video display. According to the invention the backlight is controlled to emit light during secondary time periods shorter than the primary time period between two subsequent synchronisation signals. The ratio of the time during which the backlight emits light and the secondary time period determines the maximum brightness of the image. For maximum brightness the backlight may also be controlled to emit light during the whole secondary time period or during the whole primary period between two subsequent synchronisation signals. The light emitted by the backlight will be integrated in the observer's eye over time and over a number of subsequent images and will give the observer the perceived impression of different levels of brightness.

If the backlight is controlled to emit light only once during the primary time period between two subsequent synchronisation signals the observer may perceive a certain amount of flicker in the image. In other words, if the secondary period equals the primary period, flicker may be perceived in case the backlight is not on all the time. To avoid this phenomenon, the required total length of the time during which the backlight emits light is distributed over sub-periods in a development of the invention. It is advantageous if the sub-periods have equal lengths. It is further advantageous when the sub-periods are distributed evenly between two subsequent synchronisation signals. It is also advantageous when the ratio of the total time during which the backlight emits light and the primary time period between two subsequent synchronisation signals equals the ratio of the duration during which the backlight emits light within one sub-period and the duration of a sub-period. That is to say the mean value of the times during which the backlight is on is substantially constant during one frame period. It is, therefore, important that the length of the last sub-period equals the length of the other sub-periods during that frame period, and that the duration during which the backlight emits light is equal over the sub-periods of one frame. In other words, n times the sub-period must equal the frame period in this embodiment of the invention. For better understanding, the term “frame period” is used as a synonym for the time period between two subsequent synchronisation signals throughout this specification.

FIG. 1 shows waveforms associated with a video signal. The topmost line shows a synchronisation signal VB which indicates the start of a frame or a field. In general, the synchronisation signal indicates the start of a new image. The period of one frame extends from the rising edge of one of the synchronisation signals VB to the rising edge of the subsequent synchronisation signal VB. The next lower line labelled BLC is an exemplary output of a control circuit for controlling the backlight. The signal BLC can assume one of two binary states, either a logical “0” or a logical “1”. A frame period is divided into n sub-periods. Each sub-period comprises a number of elementary steps. The number of elementary steps per sub-period equals 100 in the example shown in FIG. 1. However, the number of elementary steps per sub-period may assume any desired value, depending on which ratio of control of the backlight is desired. The elementary steps within each sub-period are exemplarily shown in the next lower line labelled ES. For the sake of clarity only few sub-periods and only few of the elementary steps within each sub-period are shown. The number of elementary steps during which the control signal BLC assumes a logical “1” or “high”-value determines the duty cycle of the backlight control. The duty cycle determines the perceived brightness of the backlight. In the ideal case shown in FIG. 1 a frame accommodates an integer number of sub-periods. That is to say the last sub-period of that frame ends exactly when the frame ends. In order to avoid flicker each sub-period essentially has the same duty cycle. The last line in FIG. 1 demonstrates how the n sub-periods are accommodated within one frame period.

In one embodiment the light modulator for a pixel or a group of pixels having the highest brightness in the image is fully opened. Then the fraction of the one or more second time period, during which the light source is controlled to emit light, is set to a length such that the ratio between the fraction of the one ore more second time periods, during which the light source is controlled to emit light, and the respective second time period corresponds to the required brightness for that pixel or group of pixels. The ratio then determines the perceived maximum brightness of the display. As a further example, a desired ratio of control of the backlight is 1:100. The frame period is split into n sub-periods. Each of the n sub-periods is divided into 100 elementary steps. The backlight is always fully lit during the on-times and is completely switched off otherwise. If a maximum brightness of 50% is desired, the backlight is switched on during 50 of the elementary steps of each sub-period. This can for example be the first 50 steps of a sub-period, but it is also possible to use the last 50 steps of a sub-period, or 50 steps located at an arbitrary position inside the sub-period. If a maximum brightness of 25% is desired, the backlight is switched on during 25 of the elementary steps of each sub-period.

The maximum switching speed of the backlight, the frame rate and the desired ratio of control of the backlight determine the number of sub-periods. As was stated before, if the number of sub-periods is set to 1 a certain amount of flicker may be perceived, which is undesirable. The maximum switching frequency of the backlight determines the smallest possible step, or elementary step. As an example a maximum switching frequency of 200 kHz is assumed. This frequency may be given by the maximum frequency of a DC-to-DC converter that is used for powering the backlight. In this case, the number of sub-periods within a frame n multiplied with the desired ratio of control of the backlight of 1:100 and multiplied with the frame rate of the display must result in a number of smaller than 200.000. The equation to solve is n*100*75<200000, the solution is n<26,666. For this exemplary case numbers of n between 1 and approximately 27 are thus of interest.

### BRIEF DESCRIPTION OF THE DRAWINGS

The invention will be described in greater detail with reference to the drawing, in which

FIG. 1 exemplarily shows the ideal distribution of sub-periods within a frame period;

FIG. 2 exemplarily shows a non-ideal distribution of sub-periods within a frame period;

FIG. 3 schematically shows a known circuit for controlling a backlight;

FIG. 4 schematically shows a first circuit according to the invention for controlling a backlight;

FIG. 5 schematically shows a second circuit according to the invention for controlling a backlight; and

In the figures, same or similar elements are referenced with the same reference designators.

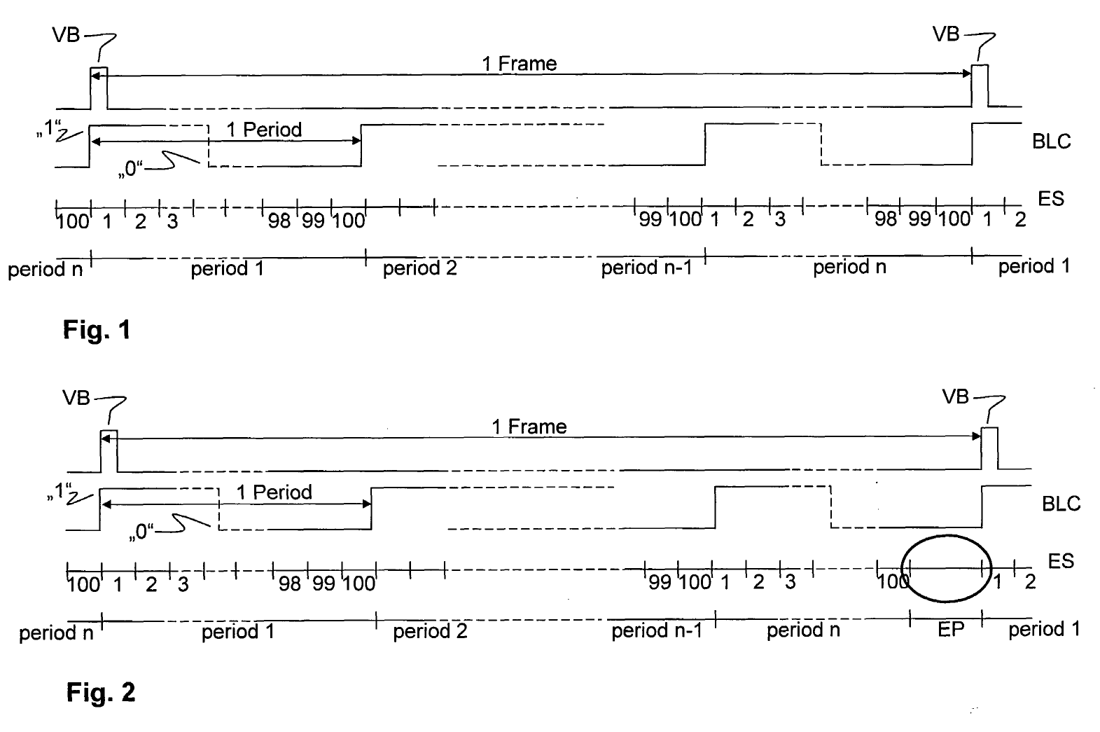

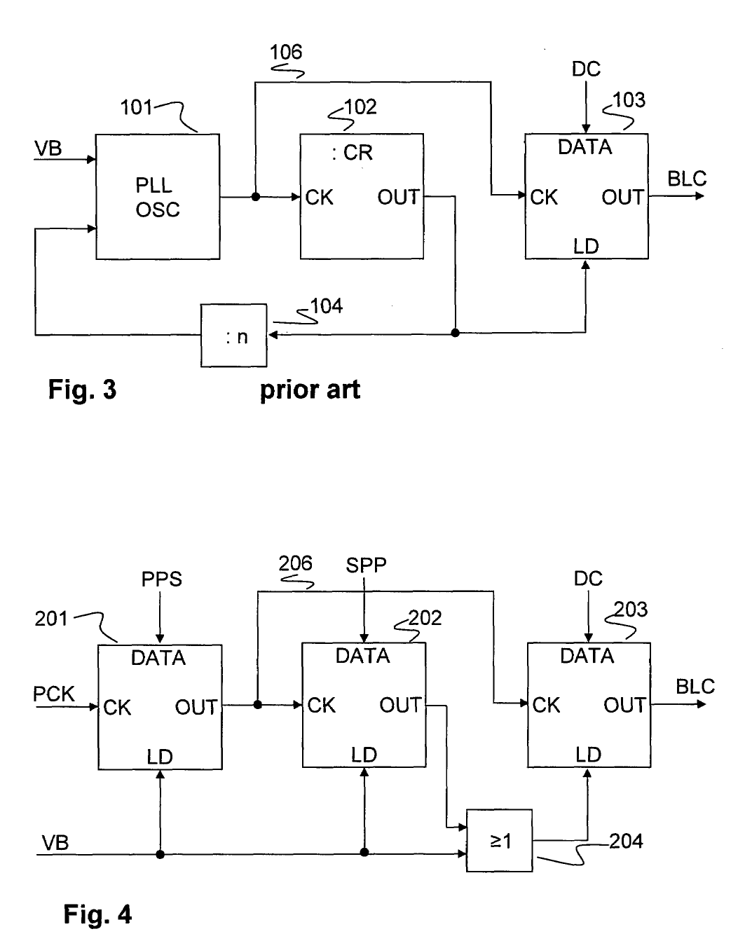

FIGS. 1 and 3 have already been described above and will not be referred to in detail again.

### DETAILED DESCRIPTION OF PREFERRED EMBODIMENTS

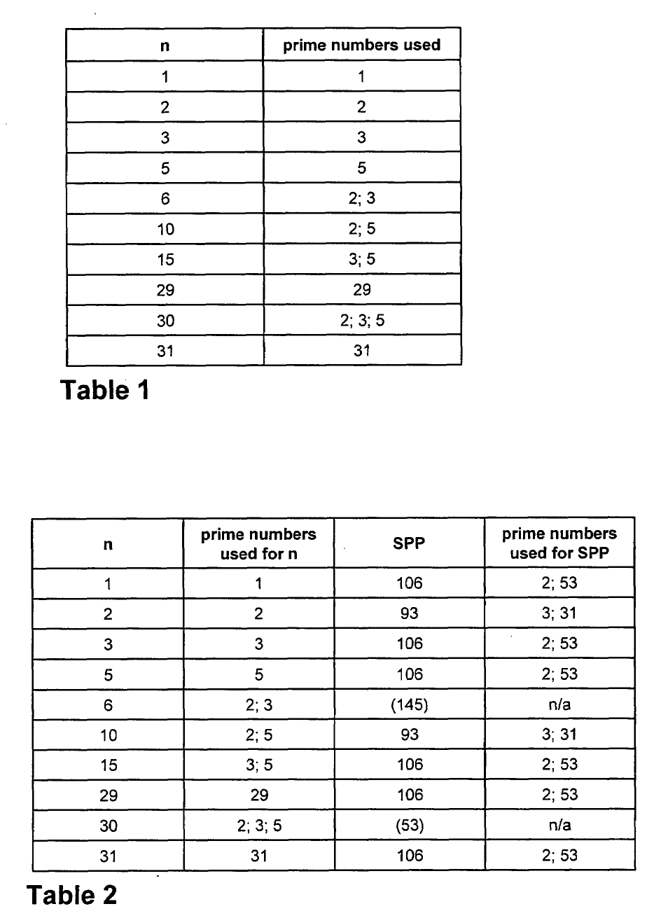

FIG. 4 shows an exemplary circuit for performing one embodiment of the inventive method, which uses the pixel clock PC and the vertical or frame synchronisation signal VB for generating a control signal BLC for the backlight. A first counter 201 is supplied with the pixel clock PC at its clock input. The number of pixel clock periods per elementary step PPS is supplied to the first counter 201 at a data input. The vertical or frame synchronisation signal VB is supplied to the load input of the first counter 201. The output of the first counter 201 is applied to the clock inputs of a second and a third counter 202, 203. The number of elementary steps per sub-period SPP is supplied to the data input of the second counter 202. The vertical or frame synchronisation signal VB is also supplied to the load input of the second counter 202. The output of the second counter 202 as well as the vertical or frame synchronisation signal VB are supplied to a logical OR-gate 204. The output of the logical OR-gate 204 is applied to the load input of the third counter 203. A value DC representing the desired ratio of on-time to period-time is supplied to the data input of the third counter 203. The value DC may also be seen as representing a duty cycle of the backlight and is used to set the maximum brightness. The output BLC of the third counter 203 controls the backlight.

During operation, the number of pixel clock periods per elementary step PPS is loaded into the first counter 201 upon the occurrence of the synchronisation signal VB at its load input. At the same time the number of elementary steps per sub-period SPP is loaded into the second counter 202 and the duty cycle DC is loaded into the third counter 203. The first, the second and the third counter 201, 202 and 203 count down with every trigger impulse at their respective clock input. The VB signal is used as a global and priority synchronisation signal for the three counters. The first counter 201 and the second counter 202 reload the values present at a data input when they have finished counting and restart counting immediately. The third counter 203 stops counting when it reaches zero. The third counter 203 preferably issues a high-level signal corresponding to a logical “1” at its output unless it has counted to zero. When the third counter 203 has counted down to zero the output assumes a low-level signal corresponding to a logical “0”. It is, however, also conceivable to invert the logic levels of the counters, depending on the actual choice. After it has counted to zero the third counter 203 waits until either a sub-period or a priority VB signal occurs at its load input for reloading the value at its data input and beginning counting down again.

In order to achieve identical sub-periods within a frame period in terms of duration and duty cycle the values supplied at the data inputs of the counters have to be scaled appropriately. Further, the added durations of the sub-periods have to fit as good as possible within one frame period. For obtaining the respective values the following equation has to be solved:

PPS*SPP*n=PPL*LPF, wherein

PPS denotes the number of pixel clock periods per elementary step, SPP denotes the number of elementary steps per sub-period, n is the number of sub-periods within one frame, PPL denotes the number of pixel clock periods per line and LPF denotes the number of lines in a frame, all of the afore-mentioned numbers being integer.

According to the method the values for pixel clock periods per line PPL and lines per frame LPF are decomposed into prime numbers. The prime numbers are then distributed and assigned as count values to the first and second counters 201, 202 counting pixel clock periods per elementary step PPS and elementary steps per sub-period SPP, as well as to the number of sub-periods in a frame n. It is now referred back to the exemplary values given further above, targeting a ratio of control for the backlight of 1:100 and a number of sub-periods within a frame between 1 and 27. In this case, only those combinations of prime numbers are used which allow for a value for elementary steps per sub-period SPP as close as possible to 100 and for which the number n of sub-periods within a frame lies between 1 and 27.

The following example is directed to a screen having WXGA format, in which a frame consists of a total of 795 horizontal lines, i.e. LPF=795, each line having 1798 pixels, i.e. PPL=1798. Hence, the total number of pixels per frame is 1429410. Further, a frame rate or repetition frequency of 75 Hz is assumed. The numbers given include the vertical and horizontal blanking interval.

The prime number decomposition of 1798 results in 2, 29 and 31. The prime number decomposition of 795 results in 3, 5 and 53. Hence, the list of prime numbers includes 2, 3, 5 29, 31, and 53.

A first step of the method includes identifying those combinations of the prime numbers in the list that allow for a value of n between 1 and 27. Table 1 shows the possible combinations.

Although the last three solutions in the table deliver a number n of sub-periods within a frame larger than the target number 27, they are not discarded. Choosing n=31 would require a switching frequency for the backlight of 31*100*75=232.5 kHz, which appears to be feasible for switch mode power converters.

The next step of the method includes identifying, for each number n of sub-periods within a frame identified above, those combinations of prime numbers the product of which is as close as possible to 100. The results for all numbers n identified in the first step are shown in table 2.

93 and 106 are the only solutions coming close to the desired value of 100. The value 100 cannot be achieved straight. The achievable ratio of control of the backlight is thus either 93 or 106. As both values can be realised using the present circuit and the present selected image resolution, the first choice would be 106, since this number is found more often than 96 in the list of possible solutions. The solutions for n having numbers 6 and 30 are discarded as the associated prime numbers result in values for SPP too far away from the desired value of 100.

The resulting count value for the number of pixel clock periods per step, PPS, can now be calculated using the remaining prime numbers, as shown in table 3.

The embodiment described above provides a simple solution for evenly distributing sub-periods within a frame period based on counting the pixel clock. However, it is not always possible to achieve a desired value for the ratio of control of the backlight. The number of possible solutions depends on the decomposition of the key figures describing the respective video mode into prime numbers. The smaller the resulting prime numbers the more solutions are possible. In the example above high prime numbers like 29, 31 and 53 are less suitable.

In a development of the inventive method and the inventive circuit, the general idea of counting the pixel clock for distributing sub-periods within a frame period and for providing a number of elementary steps within each sub-period is improved. Like before, a synchronisation signal, for example the frame or vertical synchronisation signal is used.

The development of the inventive method and the inventive circuit is based on the method described in the example above. To begin with, the desired ratio of control of the backlight is set to be fixed. For example, the ratio of control of the backlight is set to be 1:100, that is to say each sub-period is divided into 100 elementary steps or, in other words the value of SPP is set to 100. As a next step the total number of pixel clock periods per frame PPF is divided by the desired number n of sub-periods per frame multiplied by the number of elementary steps SPP. The result is the number of pixel clock periods per elementary step PPS. Written as an equation: PPS=PPF/n/SPP. For the exemplary numbers chosen above the equation would read as PPS=1429410/n/100. The result of the division may not be an integer number. Therefore, the next smaller integer number is chosen for the number of pixel clock periods per elementary step PPS. As a result n sub-periods can be accommodated within a frame period, wherein each of the n sub-periods may accommodate the same ratio or duty cycle of control of the backlight. In the example, the duty cycles, which determine the ratio of control of the backlight, can be set to any value within a range of 1:100. The sub-periods are synchronised with the frame or vertical synchronisation signal. As was stated above, the result of the equation may not always be an integer number. Therefore, an error may remain after the n-th sub-period, which may be in a range of 1 to n*SPP−1 pixel clock periods. It is to be noted that no error occurs obviously, if the result of equation is an integer number. FIG. 2 shows exemplary waveforms for the above-mentioned case. The waveforms shown in the figure generally correspond to the waveforms shown in FIG. 1. Only in the area of period n on the right-hand side of the figure a difference can be seen. Period n ends with the 100th elementary step. However, the end of the frame period has not yet been reached. A time interval forming an error period EP fills the time between the end of period n and the end of the frame period, indicated by the surrounding frame EP in FIG. 2. This error introduces a mean error to the ratio of control of the backlight during every frame. As the error occurs after the last of the n sub-periods and prior to the vertical or frame synchronisation signal a small flicker having frame frequency may also occur. The number of pixel clock periods PEP within this error period EP calculates as PPF−SPP*n*PPS and may lie between 1 and n*100−1. The mean error to the ratio of control of the backlight can be calculated as PEP/(PPF−PEP). This error to the ratio of control of the backlight is often very small and depends on the number n of sub-periods chosen, as shown in the table 4. For calculating the table the same values for the total number of pixel clock periods per frame PPF have been chosen as for the examples above. It is to be noted that the error remains constant independent of the actual duty cycle chosen.

Generally, the inventive method presented in the example above allows for creating any number n of sub-periods within a frame period in a range from 1 to 27 while essentially achieving the desired duty cycle or ratio of control of the backlight of 1:100 for any selected number of sub-periods.

The results of the embodiment described above may be acceptable in view of the relatively small error introduced. However, in order to reduce the visibility of possible flicker having frame frequency, in a further development of the inventive method correction intervals COI are introduced. At the end of a correction interval COI the counters are disabled, or set into a hold state. In other words, at the end of a correction interval COI the counters are forced to miss a single clock pulse, i.e. a clock pulse is not applied to the respective clock inputs of the counters at the end of a correction interval COI. The number of clock pulses after which a correction interval COI is inserted can be calculated as the quotient of the total number of pixel clock periods per frame and the number of pixel clock periods in the error period PEP, or COI=PPF/PEP. In doing so the end of the last of the n sub-periods within a frame period substantially coincides with the end of the frame period. The flicker having frame frequency is thus substantially eliminated.

In this embodiment of the invention, the missed clock pulses appear at regular intervals within a frame regardless of the sub-period and regardless of the state of the output of the circuit. That is to say, the missed clock pulses occur regardless of whether the output of the circuit represents a logical “1” or a logical “0”, or regardless whether the light source is switched on or off. The value of the error in this embodiment of the invention depends on the value n indicating the number of sub-periods within a frame period as well as on the duty cycle. However, as a result of the introduction of the correction interval the mean error of the duty cycle is minimised when compared to the method without correction interval COI. In the method without correction interval COI the output can only assume either a logical “1” or a logical “0” during the complete error period PEP.

As the length of a correction interval can only assume integer multiples of the pixel clock period the result of the division PPF/PEP is truncated to the next smaller integer number. The final error remaining cannot be larger than one pixel clock period. This final error is truncated by the synchronisation signal and is negligible in view of the comparatively large number of pixel clock periods per frame. Table 5 shows the various values for SPP, PPS (calculated and truncated), PEP, COI (calculated and truncated), corrected number of pixel clock periods and remaining error for numbers n of sub-periods in a range of 1 to 27. For the calculation of the exemplary values in the table the same value of 1429410 pixels per frame as for the examples further above was used.

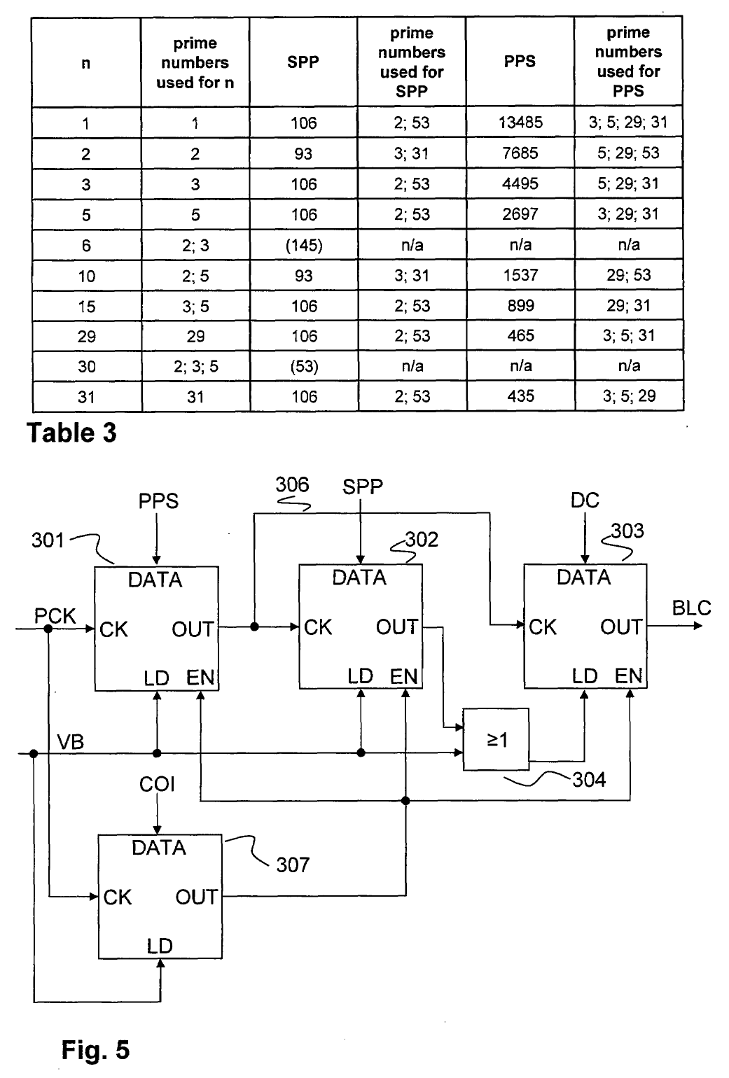

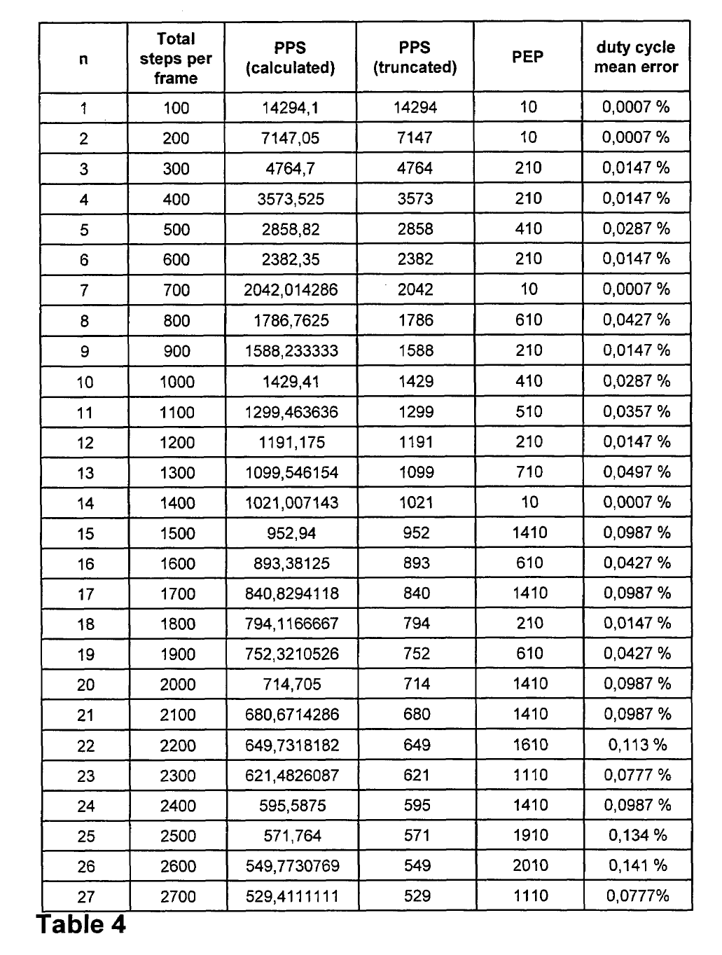

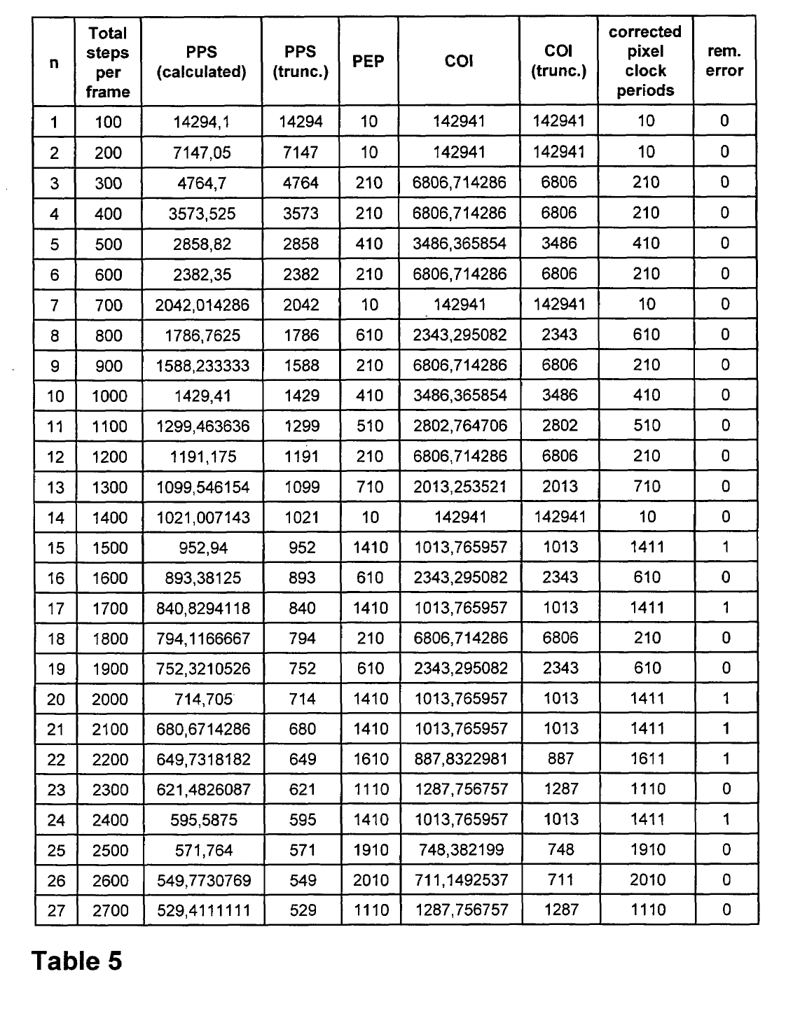

FIG. 5 shows a schematic block diagram of an exemplary circuit for performing the method described above. A large part of the circuit corresponds to the circuit described in FIG. 4. A first counter 301 is clocked with a pixel clock signal PCK. A value for the number of pixel clock periods per elementary step PPS is supplied to a data input of the first counter 301. This value is loaded into the counter upon occurrence of a synchronisation signal VB at the load input LD of the first counter 301. The synchronisation signal VB is also supplied to the load input LD of a second counter 302 and to a logical OR-gate 304. When the first counter 301 has counted down from the value PPS supplied at its data input to 1, the logical state at the output of the first counter 301 delivers a corresponding signal, e.g. a pulse, and the counter automatically restarts counting down from the PPS value. This results in a clock signal being generated from the pixel clock PCK by division in the first counter 301, each clock period having the duration of a defined number of pixel clock periods. One period of the clock signal 306 generated in this way corresponds to an elementary step. The output signal of the first counter 301 is supplied as a clock signal to the second counter 302 and to a third counter 303. The second counter counts the number of elementary steps per sub-period. The second counter 302 is supplied with a desired number SPP of elementary steps per sub-period at its data input. When the second counter 302 has counted down from the value SPP supplied to 1, its output delivers a pulse and it automatically restarts counting down from the SPP value. The output of the second counter 302 is supplied to the logical OR-gate 304. The output of the logical OR-gate 304 is supplied to the load input LD of the third counter 303. A desired duty cycle DC corresponding to the desired brightness of the backlight is supplied to the third counter 303 at its data input and is loaded into the counter upon occurrence of a trigger signal at the load input of the counter. As has been elucidated before the trigger signal for the third counter 303 can either be an output signal of the second counter 302 or a synchronisation signal VB. The output of the third counter is a control signal BLC for switching on or off the backlight. The duration during which the backlight is switched on during a sub-period is determined by the duty cycle DC supplied to the data input of the third counter 303. The function of the circuit described until here corresponds to the function of the circuit described with reference to FIG. 4. A fourth counter 307 is supplied, to the data input of which a value corresponding to a correction interval COI is supplied. The fourth counter 307 is clocked by the pixel clock PCK. The value corresponding to the correction interval COI is loaded into the fourth counter 307 upon occurrence of the synchronisation signal VB at the load input LD of the fourth counter 307. The first, the second and the third counter 301, 302 and 303 have enable inputs EN, which enable or inhibit the counting down function of the respective counters. The output signal of the fourth counter 307 is connected to the respective enable inputs EN of the first, the second and the third counter 301, 302 and 303. Whenever the fourth counter 307 has counted down from the value corresponding to the correction interval COI to 1, its output delivers a pulse for one pixel clock period duration. As a result, the first, the second and the third counter 301, 302 and 303 are disabled and do not count the following incoming clock pulse. The fourth counter 307 then automatically restarts counting down from the COI value. It is to be noted that instead of supplying the output of the fourth counter 307 to enable inputs of the other counters it is also possible to interrupt the supply of clock signals to the counters. This could be done, for example by shorting the clock signals to ground using transistors or by switching and opening the clock line using transmission gates.

In another embodiment, the length number PEP of pixel clock periods in the error period is divided by the number n of sub-periods within a frame period. The integer part of the result of the division is used as a correction period COP. At the end or at the beginning of each sub-period the counters are set into a hold state for a number of clock cycles corresponding to the correction period COP. Doing so, the error period is distributed more evenly across the frame period. Only after the end of the correction period COP the hold state is released and the counters are enabled correspondingly, continuing normal operation. By distributing the error period across the frame period the end of the last sub-period of one frame matches the end of the frame period as good as possible. This embodiment of the invention, too, substantially eliminates the flicker having frame frequency. This embodiment, however, does not reduce the mean error of the duty cycle.

It is to be noted that although the method has been described above with reference to a frame period as the basis for calculation, it is also conceivable to apply the method based on the field frequency in the case of interlaced video, or on the line frequency. That is to say, the number of pixels that is used as a starting point may also be the number of pixels per field or per line.

It is further to be noted that, although the invention has been described above with reference to a certain video format in terms of pixels per frame and frames per second, the invention may be modified for other video formats without departing from the scope of the invention.

It is to be noted that the invention is particularly suitable for hold-type light valves, in which the value for transmission or reflection is maintained once it is set until it is replaced by a new value for the next frame or field.

What is claimed, is:

1. A method for driving a display apparatus, wherein an image is composed by pixels that are arranged in rows and columns, wherein the apparatus reproduces images by controlling the amount of light, which is provided to individual or groups of pixels by a light source, by means of light modulators for individual pixels or groups of pixels, thereby achieving brightness control over a first contrast ratio range, wherein subsequent images are synchronised to each other by synchronisation signals regularly occurring at intervals corresponding to first time periods, the method including the steps of:
accommodating one or more second time periods within the first time periods;
controlling the light source to emit light during fractions of the one or more second time periods;
wherein the method further includes the steps of:
determining a number of third time periods corresponding to pixel clock pulses that can be accommodated within fourth time periods;
counting the number of third time periods determined before, for generating the fourth time periods;
determining a number of fourth time periods to be accommodated within each of the one or more second time periods, wherein the fraction of the second time period during which the light source is controlled to emit light is determined by counting a corresponding number of fourth time periods.

2. The method of claim 1, wherein, in the case more than one second time periods are accommodated within the first time period, these second time periods are of equal length and/or equally distributed within the first time period.

3. The method of claim 1, wherein, in the case more than one second time periods are accommodated within the first time period, for those second time periods belonging to the same first time period, the fractions of the second time periods, during which the light source is controlled to emit light, have the same relative length with regard to the respective second time period, and wherein the ratio between the fraction and the second time period corresponds to a desired second contrast ratio.

4. The method of claim 1, further including:
fully opening the light modulator for the pixel or groups of pixels having the highest brightness in the image; and
setting the fraction of the one or more second time periods, during which the light source is controlled to emit light, to a length such that the ratio between the fraction of the one ore more second time periods, during which the light source is controlled to emit light, and the respective second time period corresponds to the required brightness for that pixel or group of pixels, wherein the ratio determines the perceived maximum brightness of the display.

5. The method of claim 1, wherein, in the case more than one second time periods are accommodated within the first time period, the method further includes:
calculating the sum of the third time periods over all second time periods within a first time period;
subtracting the sum from the total number of third time periods within a first time period; and
distributing the resulting difference in the number of third time periods at equal temporal distances within a first time period, the equal temporal distances corresponding to fifth time periods.

6. The method of claim 5, further including:
disabling the counting during one third time period after every fifth time period.

7. The method of claim 1, further including:
synchronizing the begin or the end of the light emission of the light source with the synchronisation signal.

8. The method of claim 7, wherein the synchronisation signal includes a vertical or horizontal blanking signal.

9. A circuit for controlling a light source in a display apparatus, in which an image is composed by pixels that are arranged in rows and columns, wherein the display apparatus reproduces images by controlling the amount of light, which is provided to individual or groups of pixels by a light source, by means of light modulators for individual pixels or groups of pixels, wherein subsequent images are synchronised to each other by synchronisation signals regularly occurring at intervals corresponding to first time periods, wherein the circuit includes a first counter counting a predetermined number of third time periods, the third time periods corresponding to pixel clock pulses, the predetermined number of third time periods corresponding to a fourth time period, wherein the circuit further includes a second counter counting a predetermined number of fourth time periods, wherein the predetermined number of fourth time periods counted by the second counter corresponds to a fraction of a second time period during which the light source is controlled to emit light, wherein the circuit further includes a third counter counting a predetermined number of fourth time periods, the predetermined number of fourth time periods corresponding to a second time period during which the light source is controlled to be illuminated.

10. The circuit of claim 9, wherein a fourth counter is provided, which is adapted to inhibit the first, the second and the third counters during one third time period after counting to a predetermined value, after expiry of which third time period the first, the second and the third counters resume counting.

11. The circuit of claim 9, wherein the first, the second, the third and the fourth counters, respectively, are reset and restarted by the synchronisation signal and that the third counter is also reset and restarted by the second counter after it has counted to the predetermined number.
